(19) United States
(12) Patent Application Publication
(10) Pub. No.: US 2015/0375583 A1
(43) Pub. Date: Dec. 31, 2015

(54) REINFORCED TIRE VALVE OF TIRE PRESSURE DETECTING DEVICE

(71) Applicant: E-LEAD ELECTRONIC CO., LTD., Changhua (TW)

(72) Inventor: Stephen CHEN, CHANGHUA (TW)

(21) Appl. No.: 14/319,199

(22) Filed: Jun. 30, 2014

(51) Int. Cl. B60C 29/00; B60C 29/02; B60C 23/04

(52) U.S. Cl. CPC B60C 29/005; B60C 23/0494; B60C 29/02

(57) ABSTRACT

A reinforced tire valve is disclosed. The reinforced tire valve comprises a tube body, a flexible sleeve and a tire pressure detecting device, wherein the casing of the tire pressure detecting device presses against the clamping part, which can not only prevent the flexible sleeve from being twisted out of shape due to aging, but also can transfer the torsional force generated from the centrifugal force to the flexible sleeve to prevent the reinforced tire valve from being skewed by the centrifugal force, whereby the tire will not leak even if the vehicle moves at high speed.

### BACKGROUND OF THE INVENTION

(a) Field of the Invention

The present invention generally relates to a reinforced tire valve of a tire pressure detecting device, in particular to a reinforced tire valve of a tire pressure detecting device can effectively prevent the tire of a vehicle from leaking when the vehicle moves at high speed, wherein the reinforced tire valve can prevent the flexible sleeve from being skewed due to the centrifugal force to enhance the durability of the tire valve against the centrifugal force, whereby the tire will not leak even if the vehicle moves at high speed.

(b) Description of the Prior Art

Safe driving is subject to stable tire pressure; therefore, the tire pressure monitor (or device) has become an important accessory for a car. In general, the tire pressure monitor is usually installed on the tire valve of a wheel. In order to achieve weight reduction, the material of tire valve is usually made of aluminum instead of copper. However, in temperature and cold zones, it is inclined to snow in winter; therefore, people will spread salt over roads in order to remove snow from the roads. The tire valve made of aluminum may be eroded by salt, which may result in the aging of the tire valve and tire leak.

The rubber tire valve shown in FIG. 1 is designed to solve the above problem. There is a copper tube 11 inside the tire valve, and the copper tube 11 is covered by a rubber sleeve 12. The rubber sleeve 12 is disposed with the blocking edge 13 for engaging with a wheel rim in order to make sure the inner side of the tire valve fit over the inner surface of the wheel rim. The copper tube 11 is further disposed with the external thread portion 111 for engaging with a corresponding internal thread portion 141 inside the valve cover 14. In addition to the above configuration, the pressure from the tire will further fix the valve cover 14 to prevent from tire leak. Similar devices are disclosed by TW 13344539, TW M312444, TW 1388752 and TW publication No. 201343429, etc.

The above conventional devices can actually solve some problems about tire leak. However, if the vehicle moves at high speed, the aforementioned rubber tire valve 1 will be pressed toward the inside of the wheel by the centrifugal force, and the force that the groove 13 engages with the wheel rim and the force from the tire pressure will also be cancelled by the centrifugal force, so that the inner surface of the rubber tire valve 1 cannot tightly fit over the inner surface of the wheel rim, which will result in tire leak. Thus, rubber valves are not suitable for vehicles moving at high speed, especially for those moving at the no-speed-limit German freeway.

### SUMMARY OF THE INVENTION

Therefore, it is a primary objective of the present invention to provide a reinforced tire valve of a tire pressure detecting device can effectively prevent the tire of a vehicle from leaking when the vehicle moves at high speed, wherein the reinforced tire valve can prevent the flexible sleeve from being skewed by the centrifugal force to enhance the durability of the tire valve against the centrifugal force, whereby the tire will not leak even if the vehicle moves at high speed.

To achieve the foregoing objective, the first embodiment of the present invention provides a reinforced tire valve. The reinforced tire valve may comprise a tube body, a flexible sleeve and a tire pressure detecting device. The flexible sleeve may be hollow, and the tube body may be capped by the flexible sleeve. The outer surface of the flexible sleeve may be disposed with a first blocking edge, a slot and a clamping part, wherein the slot may be engaged with a wheel rim, and the bottom of the first blocking edge may press against the outer surface of the wheel rim, and the upper edge of the clamping part may press against the inner surface of the wheel rim. The tire pressure detecting device can detect the tire pressure of a vehicle, wherein the tire pressure detecting device may be connected to the tube body and the casing of the tire pressure detecting device may press against the clamping part to reinforce the flexible sleeve in order to further fix the flexible sleeve.

In a preferred embodiment of the present invention, the flexible sleeve may further comprise a second blocking edge, and the reinforced tire valve may further comprise a collar. When the reinforced tire valve is installed on the wheel rim, the collar may fit tightly around the flexible sleeve, and the top of the collar may press against the second blocking edge and the bottom of the collar may press against the outer surface of the wheel rim.

In a preferred embodiment of the present invention, the tube body may further comprise a second blocking edge, and the reinforced tire valve may further comprise a collar, when the reinforced tire valve is installed on the wheel rim, the collar may fit tightly around the flexible sleeve, and the top of the collar may press against the second blocking edge and the bottom of the collar may press against the outer surface of the wheel rim.

In a preferred embodiment of the present invention, the reinforced tire valve may further comprise a valve cover, wherein the bottom of the valve cover may be disposed with a second blocking edge and the second blocking edge may be above the flexible sleeve. The reinforced valve may further comprise a collar. When the reinforced tire valve may be installed on the wheel rim, the collar may fit tightly around the flexible sleeve, and the top of the collar may press against the second blocking edge and the bottom of the collar may press against the outer surface of the wheel rim.

To achieve the foregoing objective, the second embodiment of the present invention further provides a reinforced tire valve. The reinforced tire valve may comprise a tube body, a flexible sleeve, a hard pad and a tire pressure detecting device. The flexible sleeve may be hollow, and the tube body may be capped by the flexible sleeve. The outer surface of the flexible sleeve may be disposed with a first blocking edge, a slot and a clamping part, wherein the slot may be engaged with a wheel rim, and the bottom of the first blocking edge may press against the outer surface of the wheel rim, and the upper edge of the clamping part may press against the inner surface of the wheel rim. The hard pad may fit tightly around the bottom of the tube body to reinforce the flexible sleeve in order to further fix the flexible sleeve. The tire pressure detecting device can detect the tire pressure of a vehicle, wherein the tire pressure detecting device may be connected to the tube body and the casing of the tire pressure detecting device may press against the hard pad

In a preferred embodiment of the present invention, the flexible sleeve may further comprise a second blocking edge, and the reinforced tire valve may further comprise a collar. When the reinforced tire valve is installed on the wheel rim, the collar may fit tightly around the flexible sleeve, and the top of the collar may press against the second blocking edge and the bottom of the collar may press against the outer surface of the wheel rim.

In a preferred embodiment of the present invention, the tube body may further comprise a second blocking edge, and the reinforced tire valve may further comprise a collar. When the reinforced tire valve is installed on the wheel rim, the collar may fit tightly around the flexible sleeve, and the top of the collar may press against the second blocking edge and the bottom of the collar may press against the outer surface of the wheel rim.

In a preferred embodiment of the present invention, the reinforced tire valve may further comprise a valve cover, wherein the bottom of the valve cover may be disposed with a second blocking edge and the second blocking edge may be above the flexible sleeve, and the reinforced valve may further comprise a collar. When the reinforced tire valve is installed on the wheel rim, the collar may fit tightly around the flexible sleeve, and the top of the collar may press against the second blocking edge and the bottom of the collar may press against the outer surface of the wheel rim.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a 3D exploded view of a conventional rubber tire valve.

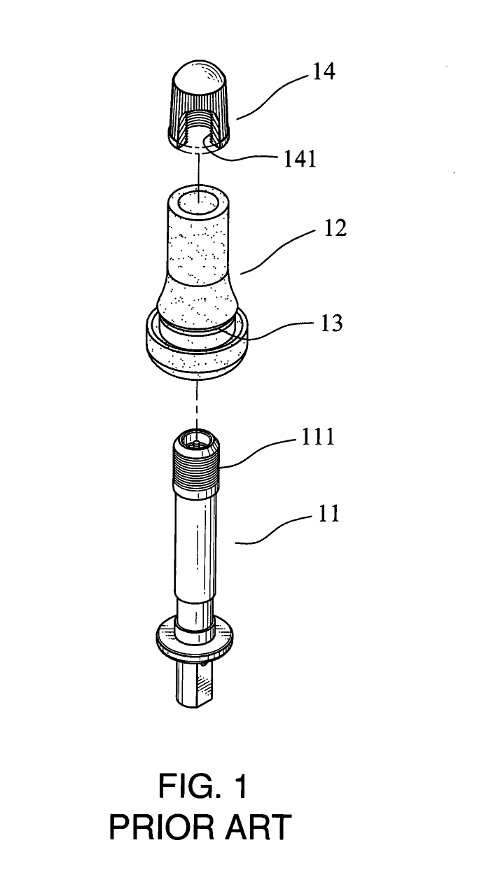

FIG. 2 is a schematic view of the first embodiment in accordance with the present invention.

FIG. 3 is a 3D exploded view of the first embodiment in accordance with the present invention.

FIG. 4 is a schematic view of the embodiment one of a second blocking edge in accordance with the present invention (1).

FIG. 5 is a schematic view of the embodiment one of a second blocking edge in accordance with the present invention (2).

FIG. 6 is a schematic view of the embodiment two of a second blocking edge in accordance with the present invention.

FIG. 7 is a schematic view of the embodiment three of a second blocking edge in accordance with the present invention.

FIG. 8 is a schematic view of the second embodiment in accordance with the present invention.

FIG. 9 is a 3D exploded view of the second embodiment in accordance with the present invention.

FIG. 10 is a schematic view of the embodiment one of the second embodiment of a second blocking edge in accordance with the present invention (1).

### DETAILED DESCRIPTION OF THE PREFERRED EMBODIMENTS

The technical content of the present invention will become apparent by the detailed description of the following embodiments and the illustration of related drawings as follows.

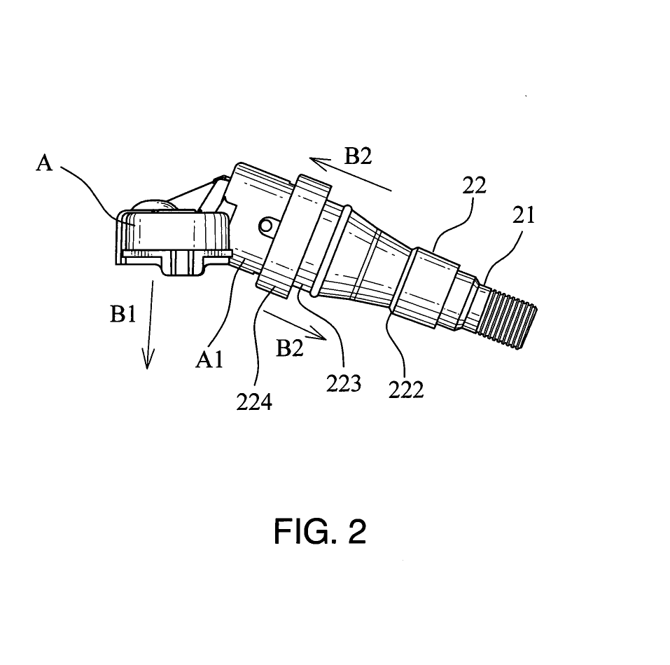

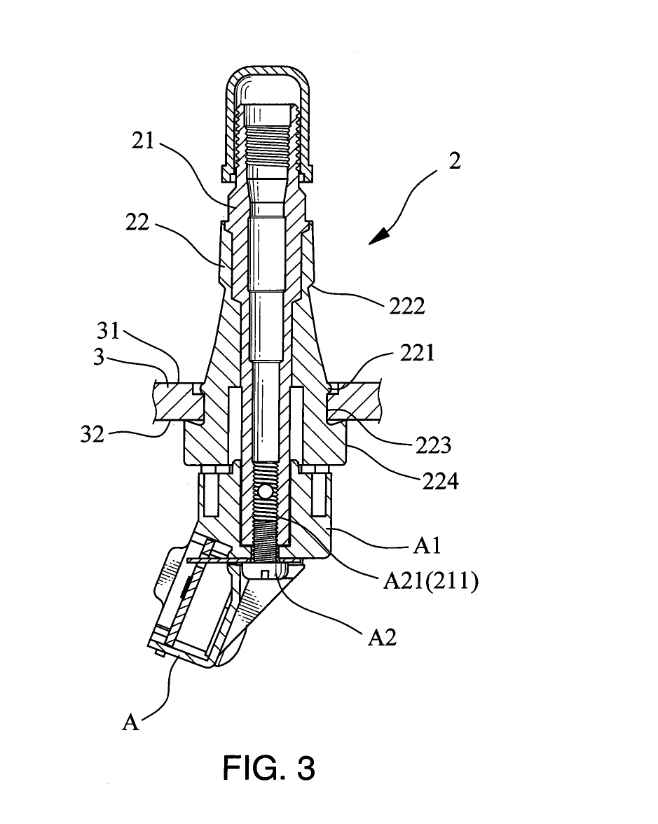

With reference to FIG. 2 and FIG. 3 for the first embodiment of a reinforced tire valve 2 of a tire pressure detecting device A in accordance with the present invention, the reinforced tire valve 2 comprises a tube body 21, a flexible sleeve 22 and a tire pressure detecting device A.

The tube body 21 is made of metal. The flexible sleeve 22 is hollow, and the outer surface of the tube body 21 is capped by the flexible sleeve 22. The flexible sleeve 22 is made of rubber and the outer surface of the flexible sleeve 22 is disposed with a first blocking edge 221, a slot 223 and a clamping part 224, wherein the slot 223 is engaged with a wheel rim 3, and the bottom of the first blocking edge 221 presses against the outer surface 31 of the wheel rim 3, and the upper edge of the clamping part 224 presses against the inner surface 32 of the wheel rim 3. The tire pressure detecting device A can be used to detect the tire pressure of a vehicle, wherein the tire pressure detecting device A is connected to the tube body 21 and the casing A1 of the tire pressure detecting device A presses against the clamping part 224 to reinforce the flexible sleeve 22 in order to further fix the flexible sleeve 22.

The tire pressure detecting device A is connected to the tube body 21 via a bolt A2, wherein the outer screw thread A21 of the bolt A2 is engaged with the inner screw hold 211 at the bottom of the tube body 21, whereby the tire pressure detecting device A can be tightly fixed on the tube body 21.

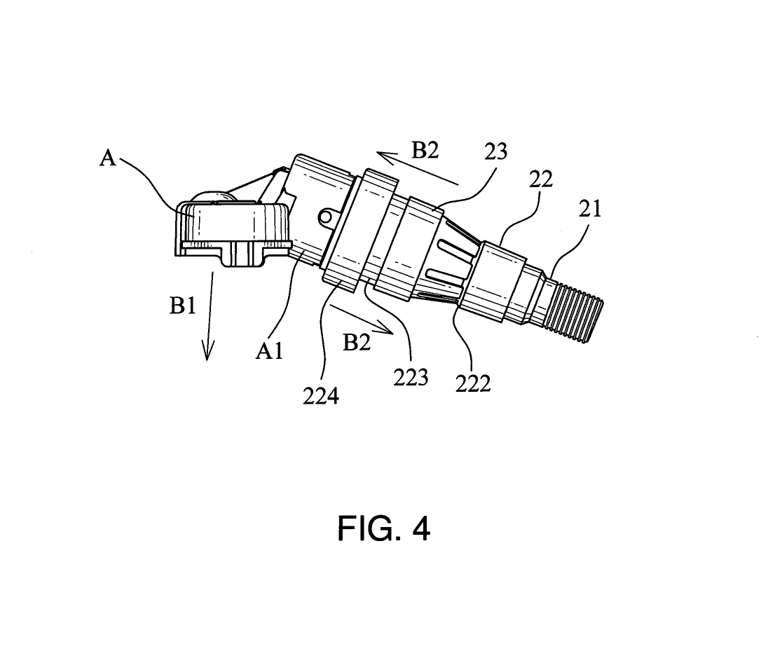

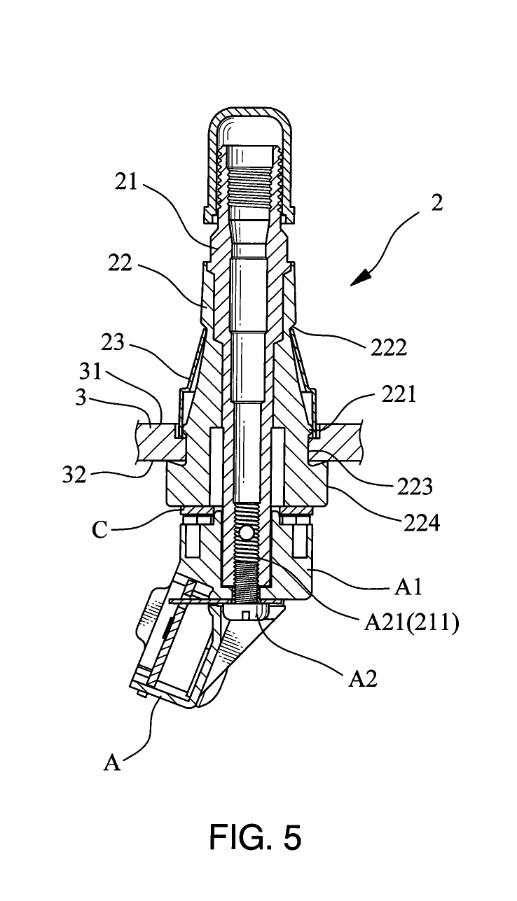

The embodiment one of the second blocking edge of the first embodiment in accordance with the present invention is as shown in FIG. 4 and FIG. 5, wherein the flexible sleeve 22 further comprises a second blocking edge 222.

The reinforced tire valve 2 further comprises a collar 23, which can be made of metal or plastics. When the reinforced tire valve 2 is installed on the wheel rim 3, the collar 23 can fit tightly around the flexible sleeve 22, and the top of the collar 23 presses against the second blocking edge 222, and the bottom of the collar 23 presses against the outer surface 31 of the wheel rim 3.

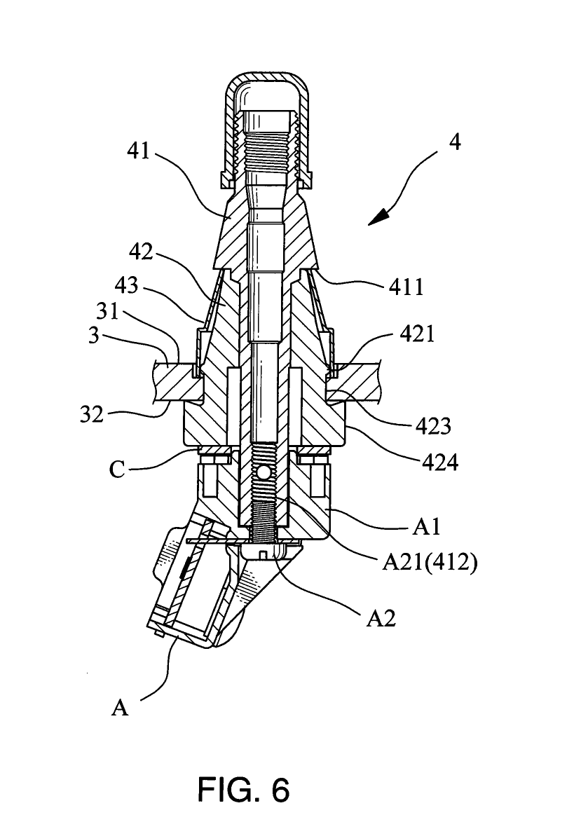

With reference to FIG. 6 for the embodiment two of the second blocking edge of the first embodiment in accordance with the present invention, the reinforced tire valve 4 comprises a tube body 41, a flexible sleeve 42 and a tire pressure detecting device A.

The outer surface of the tube body 21 is disposed with a second blocking edge 411. The flexible sleeve 42 is hollow, and the outer surface of the tube body 41 is capped by the flexible sleeve 42. The flexible sleeve 22 is made of rubber and the outer surface of the flexible sleeve 42 is disposed with a first blocking edge 421, a slot 423 and a clamping part 424, wherein the slot 423 is engaged with a wheel rim 3, and the bottom of the first blocking edge 421 presses against the outer surface 31 of the wheel rim 3, and the upper edge of the clamping part 424 presses against the inner surface 32 of the wheel rim 3. The tire pressure detecting device A can be used to detect the tire pressure of a vehicle, wherein the tire pressure detecting device A is connected to the tube body 41 and the casing A1 of the tire pressure detecting device A presses against the clamping part 424 to reinforce the flexible sleeve 42 in order to further fix the flexible sleeve 42.

The tire pressure detecting device A is connected to the tube body 41 via a bolt A2, wherein the outer screw thread A21 of the bolt A2 is engaged with the inner screw hold 412 at the bottom of the tube body 41, whereby the tire pressure detecting device A can be tightly fixed on the tube body 41.

The reinforced tire valve 4 further comprises a collar 43, which can be made of metal or plastics. When the reinforced tire valve 4 is installed on the wheel rim 3, the collar 43 can fit tightly around the flexible sleeve 42, and the top of the collar 43 presses against the second blocking edge 411, and the bottom of the collar 43 presses against the outer surface 31 of the wheel rim 3.

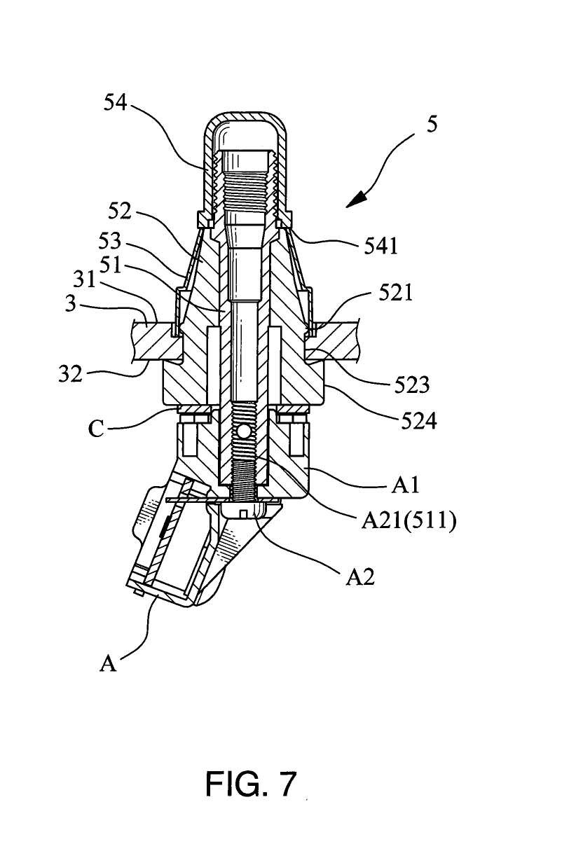

With reference to FIG. 7 for the embodiment three of the second blocking edge of the first embodiment in accordance with the present invention, the reinforced tire valve 5 comprises a tube body 51, a flexible sleeve 52 and a tire pressure detecting device A.

The top of the outer surface of the tube body 51 is capped by a valve cover 54. The flexible sleeve 52 is hollow, and the outer surface of the tube body 51 is capped by the flexible sleeve 52. The flexible sleeve 22 is made of rubber and the outer surface of the flexible sleeve 42 is disposed with a first blocking edge 521, a slot 523 and a clamping part 524, wherein the slot 523 is engaged with a wheel rim 3, and the bottom of the first blocking edge 521 presses against the outer surface 31 of the wheel rim 3, and the upper edge of the clamping part 524 presses against the inner surface 32 of the wheel rim 3. The tire pressure detecting device A can be used to detect the tire pressure of a vehicle, wherein the tire pressure detecting device A is connected to the tube body 51 and the casing A1 of the tire pressure detecting device A presses against the clamping part 524 to reinforce the flexible sleeve 52 in order to further fix the flexible sleeve 52.

The bottom of the valve cover 54 is disposed with a second blocking edge 541, and the second blocking edge 541 is above the flexible sleeve 52.

The reinforced tire valve 5 further comprises a collar 53, which can be made of metal or plastics. When the reinforced tire valve 5 of the tire pressure detecting device A is installed on the wheel rim 3, the collar 53 can fit tightly around the flexible sleeve 52, and the top of the collar 53 presses against the second blocking edge 541, and the bottom of the collar 53 presses against the outer surface 31 of the wheel rim 3.

The tire pressure detecting device A is connected to the tube body 51 via a bolt A2, wherein the outer screw thread A21 of the bolt A2 is engaged with the inner screw hold 511 at the bottom of the tube body 51, whereby the tire pressure detecting device A can be tightly fixed on the tube body 51.

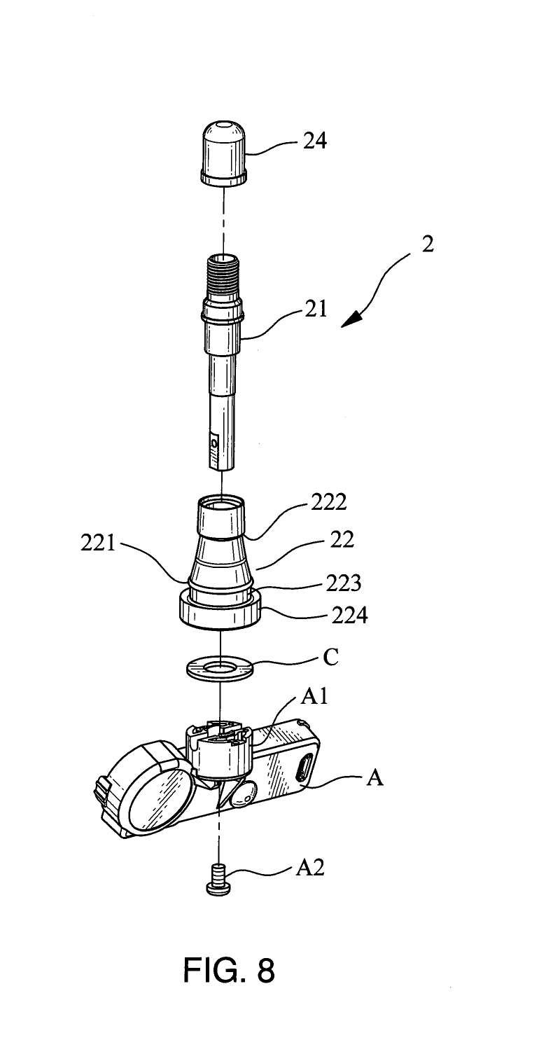

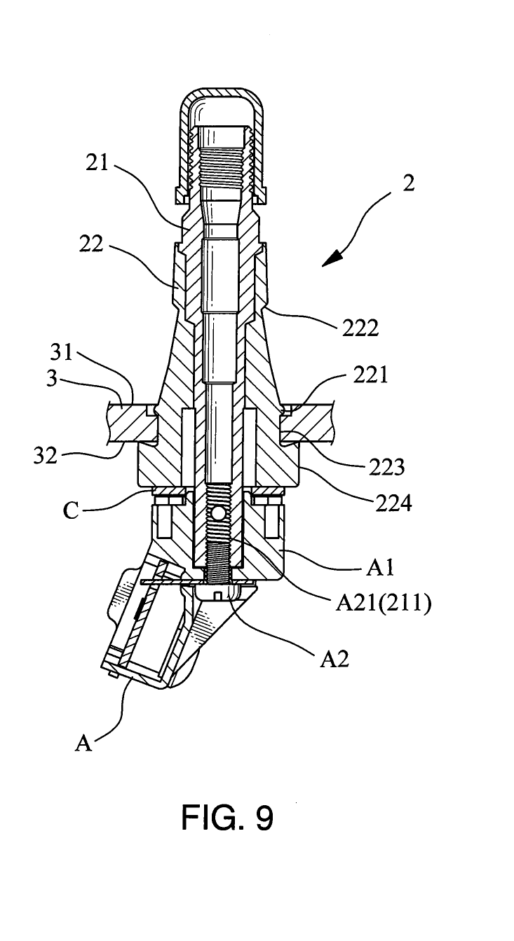

With reference to FIG. 8 and FIG. 9 for the second embodiment of a reinforced tire valve 2 of a tire pressure detecting device A in accordance with the present invention, the reinforced tire valve 2 comprises a tube body 21, a flexible sleeve 22, a hard pad C and a tire pressure detecting device A.

The tube body 21 is made of metal. The flexible sleeve 22 is hollow, and the outer surface of the tube body 21 is capped by the flexible sleeve 22. The flexible sleeve 22 is made of rubber and the outer surface of the flexible sleeve 22 is disposed with a first blocking edge 221, a slot 223 and a clamping part 224, wherein the slot 223 is engaged with a wheel rim 3, and the bottom of the first blocking edge 221 presses against the outer surface 31 of the wheel rim 3, and the upper edge of the clamping part 224 presses against the inner surface 32 of the wheel rim 3. The hard pad C can be made of metal, plastics or a hard material. The hard pad C fits tightly around the bottom of the tube body 21 to reinforce the flexible sleeve 22 in order to further fix the flexible sleeve 22. The tire pressure detecting device A can be used to detect the tire pressure of a vehicle, wherein the tire pressure detecting device A is connected to the tube body 21 and the casing A1 of the tire pressure detecting device A presses against the clamping part 224 to reinforce the flexible sleeve 22 in order to further fix the flexible sleeve 22.

The tire pressure detecting device A is connected to the tube body 21 via a bolt A2, wherein the outer screw thread A21 of the bolt A2 is engaged with the inner screw hold 211 at the bottom of the tube body 21, whereby the tire pressure detecting device A can be tightly fixed on the tube body 21.

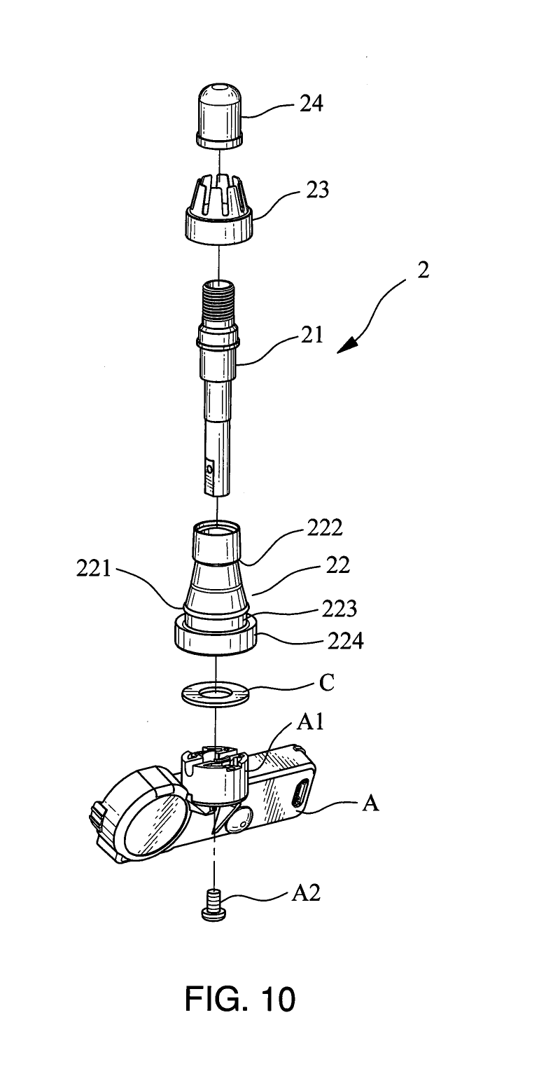

The embodiment one of the second blocking edge of the second embodiment in accordance with the present invention is as shown in FIG. 5 and FIG. 10, wherein the flexible sleeve 22 further comprises a second blocking edge 222.

The reinforced tire valve 2 further comprises a collar 23, which can be made of metal or plastics. When the reinforced tire valve 2 is installed on the wheel rim 3, the collar 23 can fit tightly around the flexible sleeve 22, and the top of the collar 23 presses against the second blocking edge 222, and the bottom of the collar 23 presses against the outer surface 31 of the wheel rim 3.

With reference to FIG. 6 for the embodiment two of the second blocking edge of the second embodiment in accordance with the present invention, the reinforced tire valve 4 comprises a tube body 41, a flexible sleeve 42, a hard pad C and a tire pressure detecting device A.

The outer surface of the tube body 21 is disposed with a second blocking edge 411. The flexible sleeve 42 is hollow, and the outer surface of the tube body 41 is capped by the flexible sleeve 42. The flexible sleeve 42 is made of rubber and the outer surface of the flexible sleeve 42 is disposed with a first blocking edge 421, a slot 423 and a clamping part 424, wherein the slot 423 is engaged with a wheel rim 3, and the bottom of the first blocking edge 421 presses against the outer surface 31 of the wheel rim 3, and the upper edge of the clamping part 424 presses against the inner surface 32 of the wheel rim 3. The hard pad C fits tightly around the bottom of the tube body 41 to reinforce the flexible sleeve 42 in order to further fix the flexible sleeve 42. The tire pressure detecting device A can be used to detect the tire pressure of a vehicle, wherein the tire pressure detecting device A is connected to the tube body 41 and the casing A1 of the tire pressure detecting device A presses against the clamping part 424 to reinforce the flexible sleeve 42 in order to further fix the flexible sleeve 42.

The tire pressure detecting device A is connected to the tube body 41 via a bolt A2, wherein the outer screw thread A21 of the bolt A2 is engaged with the inner screw hold 412 at the bottom of the tube body 41, whereby the tire pressure detecting device A can be tightly fixed on the tube body 41.

The reinforced tire valve 4 further comprises a collar 43, which can be made of metal or plastics. When the reinforced tire valve 4 of the tire pressure detecting device A is installed on the wheel rim 3, the collar 43 can fit tightly around the flexible sleeve 42, and the top of the collar 43 presses against the second blocking edge 411, and the bottom of the collar 43 presses against the outer surface 31 of the wheel rim 3.

With reference to FIG. 7 for the embodiment three of the second blocking edge of the second embodiment in accordance with the present invention, the reinforced tire valve 5 comprises a tube body 51, a flexible sleeve 52, a hard pad C and a tire pressure detecting device A.

The top of the outer surface of the tube body 51 is disposed with a valve cover 54. The flexible sleeve 52 is hollow, and the outer surface of the tube body 51 is capped by the flexible sleeve 52. The flexible sleeve 52 is made of rubber and the outer surface of the flexible sleeve 52 is disposed with a first blocking edge 521, a slot 523 and a clamping part 524, wherein the slot 523 is engaged with a wheel rim 3, and the bottom of the first blocking edge 521 presses against the outer surface 31 of the wheel rim 3, and the upper edge of the clamping part 524 presses against the inner surface 32 of the wheel rim 3. The hard pad C fits tightly around the bottom of the tube body 51 to reinforce the flexible sleeve 52 in order to further fix the flexible sleeve 52. The tire pressure detecting device A can be used to detect the tire pressure of a vehicle, wherein the tire pressure detecting device A is connected to the tube body 51 and the casing A1 of the tire pressure detecting device A presses against the clamping part 524 to reinforce the flexible sleeve 52 in order to further fix the flexible sleeve 52.

The bottom of the valve cover 54 is disposed with a second blocking edge 541, and the second blocking edge 541 is above the flexible sleeve 52.

The reinforced tire valve 5 further comprises a collar 53, which can be made of metal or plastics. When the reinforced tire valve 5 of the tire pressure detecting device A is installed on the wheel rim 3, the collar 53 can fit tightly around the flexible sleeve 52, and the top of the collar 53 presses against the second blocking edge 541, and the bottom of the collar 53 presses against the outer surface 31 of the wheel rim 3.

The tire pressure detecting device A is connected to the tube body 51 via a bolt A2, wherein the outer screw thread A21 of the bolt A2 is engaged with the inner screw hold 511 at the bottom of the tube body 51, whereby the tire pressure detecting device A can be tightly fixed on the tube body 51.

In summation of the description above, the reinforced tire valve of the tire pressure detecting device, as shown in FIG. 2, can enhance its durability against the centrifugal force B1, wherein the casing of the tire pressure detecting device presses against the clamping part, which can not only prevent the flexible sleeve from being twisted out of shape, but also can directly impose the torsional force generated from the centrifugal force to the flexible sleeve and indirectly impose which on the wheel rim. Besides, the collar can further reinforce the flexible sleeve, such that the inside and outside of the flexible sleeve are clamped by hard objects to further reinforce the flexible sleeve, which can prevent the reinforced tire valve from being skewed by the centrifugal force; thus, the tire will not leak even if the vehicle moves at high speed.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A reinforced tire valve, comprising:
a tube body;
a flexible sleeve, wherein the flexible sleeve is hollow, and the tube body is capped by the flexible sleeve; an outer surface of the flexible sleeve is disposed with a first blocking edge, a slot and a clamping part, wherein the slot is engaged with a wheel rim, and a bottom of the first blocking edge presses against an outer surface of the wheel rim, and an upper edge of the clamping part presses against an inner surface of the wheel rim; and
a tire pressure detecting device, for detecting a tire pressure of a vehicle, wherein the tire pressure detecting device is connected to the tube body and a casing of the tire pressure detecting device presses against the clamping part to reinforce the flexible sleeve in order to further fix the flexible sleeve.

2. The reinforced tire valve of claim 1, wherein the flexible sleeve further comprises a second blocking edge, and the reinforced tire valve further comprises a collar, when the reinforced tire valve is installed on the wheel rim, the collar fits tightly around the flexible sleeve, and a top of the collar presses against the second blocking edge and a bottom of the collar presses against the outer surface of the wheel rim.

3. The reinforced tire valve of claim 1, wherein the tube body further comprises a second blocking edge, and the reinforced tire valve further comprises a collar, when the reinforced tire valve is installed on the wheel rim, the collar fits tightly around the flexible sleeve, and a top of the collar presses against the second blocking edge and a bottom of the collar presses against the outer surface of the wheel rim.

4. The reinforced tire valve of claim 1, further comprising a valve cover, wherein a bottom of the valve cover is disposed with a second blocking edge, and the second blocking edge is above the flexible sleeve, and the reinforced valve further comprises a collar, when the reinforced tire valve is installed on the wheel rim, the collar fits tightly around the flexible sleeve, and a top of the collar presses against the second blocking edge and a bottom of the collar presses against the outer surface of the wheel rim.

5. The reinforced tire valve of claim 1, further comprising a bolt, wherein the bolt is fixed at a bottom of the tube body.

6. A reinforced tire valve, comprising:
a tube body;
a flexible sleeve, wherein the flexible sleeve is hollow, and the tube body is capped by the flexible sleeve; an outer surface of the flexible sleeve is disposed with a first blocking edge, a slot and a clamping part, wherein the slot is engaged with a wheel rim, and a bottom of the first blocking edge presses against an outer surface of the wheel rim, and an upper edge of the clamping part presses against an inner surface of the wheel rim;
a hard pad, fitting tightly around a bottom of the tube body to reinforce the flexible sleeve in order to further fix the flexible sleeve; and
a tire pressure detecting device, for detecting a tire pressure of a vehicle, wherein the tire pressure detecting device is connected to the tube body and a casing of the tire pressure detecting device presses against the hard pad.

7. The reinforced tire valve of claim 6, wherein the flexible sleeve further comprises a second blocking edge, and the reinforced tire valve further comprises a collar, when the reinforced tire valve is installed on the wheel rim, the collar fits tightly around the flexible sleeve, and a top of the collar presses against the second blocking edge and a bottom of the collar presses against the outer surface of the wheel rim.

8. The reinforced tire valve of claim 6, wherein the tube body further comprises a second blocking edge, and the reinforced tire valve further comprises a collar, when the reinforced tire valve is installed on the wheel rim, the collar fits tightly around the flexible sleeve, and a top of the collar presses against the second blocking edge and a bottom of the collar presses against the outer surface of the wheel rim.

9. The reinforced tire valve of claim 6, further comprising a valve cover, wherein a bottom of the valve cover is disposed with a second blocking edge, and the second blocking edge is above the flexible sleeve, and the reinforced valve further comprises a collar, when the reinforced tire valve is installed on the wheel rim, the collar fits tightly around the flexible sleeve, and a top of the collar presses against the second blocking edge and a bottom of the collar presses against the outer surface of the wheel rim.

10. The reinforced tire valve of claim 6, further comprising a bolt, wherein the bolt is fixed at the bottom of the tube body.
